(19) United States
(12) Patent Application Publication
(10) Pub. No.: US 2004/0240221 A1
(43) Pub. Date: Dec. 2, 2004

(54) Integrated high-beam/infrared-ray lamp system for vehicle

(76) Inventor: Jang Don Choi, Tokyo (JP)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/705,560

(22) Filed: Nov. 10, 2003

(30) Foreign Application Priority Data
May 29, 2003 (KR) 10-2003-0034405

(51) Int. Cl. F21V 11/00

(52) U.S. Cl. 362/510

(57) ABSTRACT

An integrated high-beam/infrared-ray lamp system is provided which comprises a high-beam bulb, an infrared-ray filter, an actuating device, and a lamp control unit. The high-beam bulb is disposed within a lamp housing. The infrared-ray filter is disposed in the housing, and the infrared-ray filter is allowed to rotate between a first position where the infrared-ray filter screens the high beam lamp and a second position where the infrared-ray filter does not screen the high beam lamp. The actuating device rotates the infrared-ray filter. The lamp control unit controls an on/off operation of the high beam bulb and the actuating unit. The actuating device comprises an actuator for actuating the infrared-ray filter and an elastic member connecting the infrared-ray filter and the housing.

### CROSS-REFERENCE TO RELATED APPLICATIONS

This application claims priority of Korean Application No. 10-2003-0034405, filed on May 29, 2003, the disclosure of which is incorporated fully herein by reference.

### FIELD OF THE INVENTION

The present invention relates to a head-lamp for a vehicle, and more particularly, to an integrated high-beam/infrared-ray lamp that can be used for an active night vision system.

### BACKGROUND OF THE INVENTION

In order to aid a driver's vision while driving a vehicle during night time, an active night vision system is often used. Generally, in the active night vision system, a near infrared-ray is directed from an infrared-ray lamp in a direction in front of a vehicle, and a camera mounted on the vehicle records reflected images. The recorded images are displayed on a screen, and thereby a driver can perceive objects located in front of the vehicle.

For such an active night vision system, an infrared-ray lamp is sometimes provided apart from a high beam lamp, but because of manufacturing costs or problems in layout, an integrated high-beam/infrared-ray lamp is generally used.

The integrated high-beam/infrared-ray lamp includes an infrared-ray filter disposed in a lamp housing that can screen a high-beam bulb. If the infrared-ray filter does not screen the high-beam bulb, the integrated high-beam/infrared-ray lamp operates as a high-beam lamp, and if the infrared-ray filter screens the high-beam bulb, the integrated high-beam/infrared-ray lamp operates as an infrared-ray lamp. In such a system, the infrared-ray filter is actuated by an actuator. As such, the integrated high-beam/infrared-ray lamp can operate as a high-beam lamp or an infrared-ray lamp.

However, if there is a malfunction of the actuator in a state that the infrared-ray filter screens the high-beam bulb, the high-beam cannot be used even when the high-beam bulb operates normally.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide an integrated high-beam/infrared-ray lamp in which an infrared-ray filter does not screen a high-beam bulb even when an actuator of the infrared-ray filter actuator does not operate normally, so that the integrated high-beam/infrared-ray lamp can still be used as a high-beam lamp when faults occur.

In a preferred embodiment of the present invention, the integrated high-beam/infrared-ray lamp system comprises a high-beam bulb, an infrared-ray filter, an actuating device, and a lamp control unit. The high-beam bulb is disposed within a lamp housing. The infrared-ray filter is disposed in the housing, and the infrared-ray filter is allowed to rotate between a first position where the infrared-ray filter screens the high beam lamp and a second position where the infrared-ray filter does not screen the high beam lamp. The actuating device rotates the infrared-ray filter. The lamp control unit controls on/off operation of the high beam bulb and the actuating unit. The actuating device comprises an actuator for actuating the infrared-ray filter, and an elastic member elastically connecting the infrared-ray filter and the housing.

It is preferable that the actuator is a solenoid actuator. It is further preferable that the elastic member is a coil spring. Also, preferably, the elastic member connects the lamp housing and the infrared-ray filter such that the infrared-ray filter locates at the second position when the actuator does not operate.

In another preferred embodiment of the present invention, the integrated high-beam/infrared-ray lamp system comprises a high beam bulb, an infrared-ray filter, an actuating device, and a lamp control unit. The high beam bulb is disposed within a lamp housing. The infrared-ray filter is connected to the housing, and the infrared-ray filter is allowed to rotate between a first position where the infrared-ray filter screens the high beam bulb and a second position where the infrared-ray filter does not screen the high beam bulb. The actuating device actuates the infrared-ray filter. The lamp control unit controls an on/off operation of the high beam bulb and the infrared-ray filter. The lamp control unit comprises a high beam control circuit, a switching device, and a fault determination device. The high beam control circuit generates a high beam bulb control signal to control the high beam bulb and an infrared-ray filter actuating device control signal to control the actuating device. The switching device is configured to perform an on/off operation, and the high beam control circuit is selectively connected to an external circuit that controls the high beam bulb in response to the on/off operation of the switching device. The fault determination device determines a fault of the high beam control circuit and controlling the switching device to be on/off in response to a result of the fault determination of the high beam control circuit.

It is preferable that if the fault determination device determines the high beam control circuit to be faulty, the fault determination device controls the switching device to be off such that the high beam control circuit is separated from the external circuit. Preferably, the switching device is a relay switch.

Preferably, the integrated high-beam/infrared-ray lamp comprises a night vision main switch configured to be operated to be on/off by a user, wherein the switching device is operated to be on/off in response to an on/off operation of the night vision main switch.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 shows an integrated high-beam/infrared-ray lamp system according to a preferred embodiment of the present invention in operation as a high-beam lamp;

FIG. 2 shows an integrated high-beam/infrared-ray lamp system according to a preferred embodiment of the present invention in operation as an infrared-ray lamp;

FIG. 3 shows a control unit of an integrated high-beam/infrared-ray lamp system according to a preferred embodiment of the present invention; and

FIG. 4 shows a control of the high-beam/infrared-ray lamp system according to a preferred embodiment of the present invention.

### DETAILED DESCRIPTION OF THE PREFERRED EMBODIMENTS

Hereinafter, a preferred embodiment of the present invention will be described in detail with reference to the accompanying drawings.

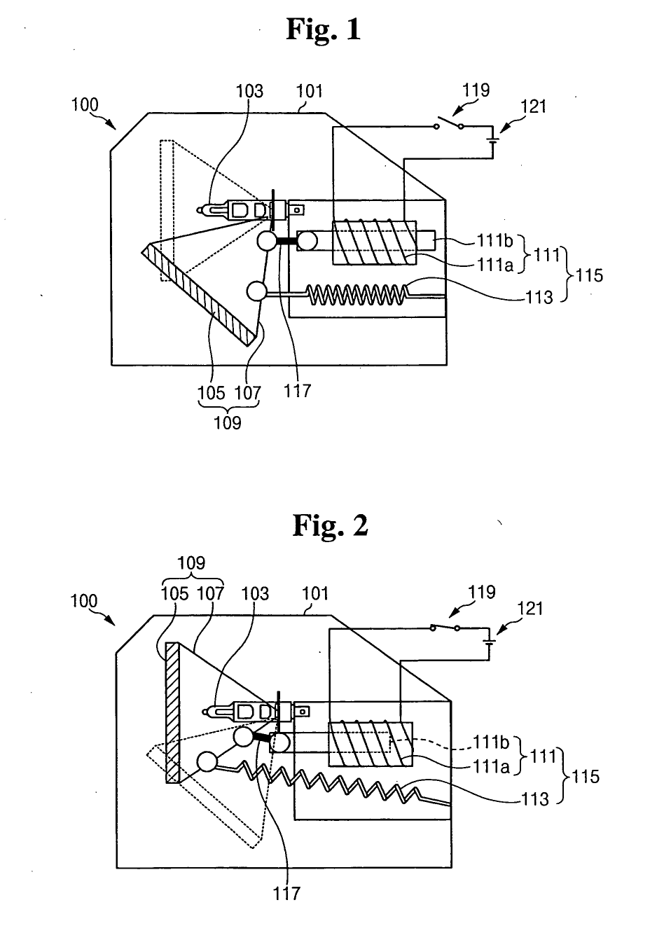

As shown in FIGS. 1 and 2, an integrated high-beam/infrared-ray lamp system 100 according to the preferred embodiment of the present invention includes a high-beam bulb 103 disposed within a lamp housing 101. When electric energy is supplied to the high-beam bulb 103, it illuminates.

An infrared-ray filter assembly 109 is rotatably connected to the lamp housing 101. The infrared-ray filter assembly 109 includes an infrared-ray transmitting filter (hereinafter simply referred to as an infrared-ray filter) 105, and a supporting frame 107 for supporting the infrared-ray filter 105.

The infrared-ray filter 105 is coupled to the supporting flame 107, and the supporting frame 107 is connected to the lamp housing 101 such that it can rotate around the high-beam bulb 103.

An infrared-ray filter actuating device 115 rotates the infrared-ray filter 105 in a predetermined range, and it includes a solenoid actuator 111 and a coil spring 113.

A general solenoid actuator can be used as the solenoid actuator 111. That is, for example, the solenoid actuator 111 includes a solenoid 111a that generates a magnetic field if it is supplied with electric current, and a magnetic rod 111b that is slidably disposed within the solenoid 111a. If current is supplied to the solenoid 111a from an external electric power source, a magnetic field is formed so that the magnetic rod 111a is urged to move.

As shown in the drawing, a connecting rod 117 pivotally connects the magnetic rod 111b and the supporting frame 107. Therefore, if the magnetic rod 111b moves in a leftward direction (in the drawing) when the solenoid actuator 111 operates, the infrared-ray filter 105 rotates in a clockwise direction (in the drawing).

One end of the coil spring 113 is connected to the infrared-ray filter assembly 109, and the other end of the coil spring 113 is connected to the lamp housing 101. The coil spring 113 is in an equilibrium state when the infrared-ray assembly 109 is positioned at a point shown in FIG. 1, such that the infrared-ray filter 105 does not screen the high-beam bulb 103 when the solenoid actuator 111 does not operate. But when the infrared-ray filter assembly 109 is positioned at a point shown in FIG. 2, a contracting force that urges the infrared-ray filter assembly to rotate in a counter-clockwise direction acts is caused by the coil spring 113. Consequently, if the solenoid actuator 111 does not operate, the infrared-ray filter assembly is positioned at a point shown in FIG. 1.

If the infrared-ray filter 109 is positioned at the point shown in FIG. 1, the integrated high-beam/infrared-ray filter system 100 operates as a high-beam lamp, and if the infrared-ray filter 109 is positioned at the point shown in FIG. 2, the integrated high-beam/infrared-ray filter system 100 operates as an infrared-ray lamp.

The solenoid 111a is selectively connected to an electric power source 121 by an operation of an on/off switch 119, and the on/off switch 119 may be controlled by a lamp control unit 123, which will be explained later. For example, the on/off switch 119 can be realized by a relay switch that is operated by an electrical signal. Furthermore, it is preferable that the high-beam bulb 103 is controlled to be on or off by a control signal of the lamp control unit.

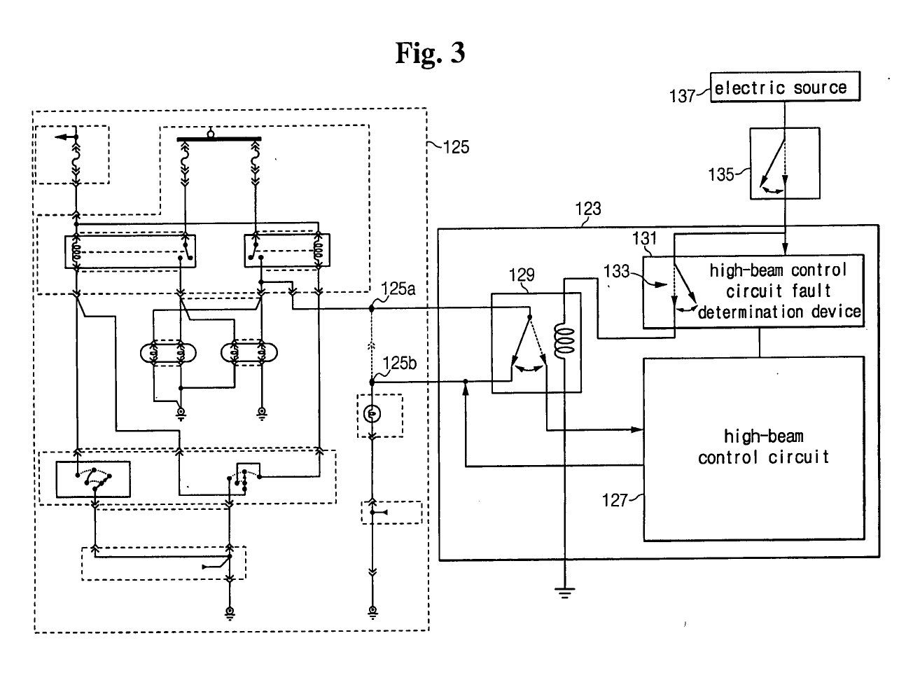

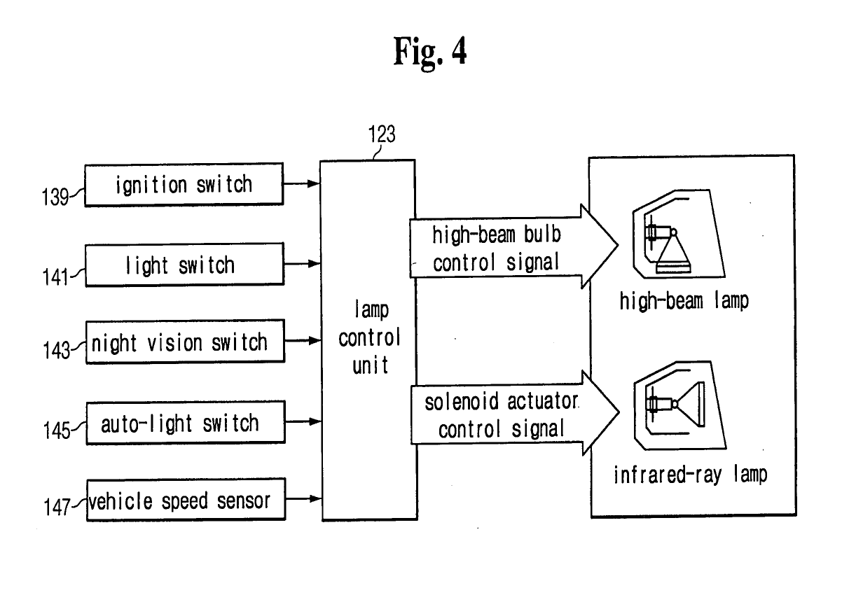

As shown in FIGS. 3 and 4, the integrated high-beam/infrared-ray lamp system 100 according to a preferred embodiment of the present invention includes the lamp control unit 123. The lamp control unit 123 controls operation of the high-beam bulb 103 and the solenoid actuator 111.

As shown in FIG. 3, the lamp control unit 123 is connected to an external electric circuit 125 that is generally provided in a vehicle. That is, two nodes 125a and 125b of the external electric circuit 125 exit the circuit and are connected to the lamp control unit 123, and the high-beam bulb 103 and the solenoid actuator 111 can be controlled by control signals of the lamp control unit 123.

The lamp control unit 123 includes a high-beam control circuit 127, a switching device 129, and a high-beam control circuit fault determination device 131.

The high-beam control circuit 127 includes a microprocessor, a memory, and other necessary hardware and software components as will be understood by persons skilled in the art, to execute the control function as described herein. The high-beam control circuit 127 is connected to or isolated from the external electric circuit 125 according to an on/off operation of the switching device 129. If the high-beam control circuit 127 is connected to the external electric circuit 125, the high-beam control circuit 127 generates control signals for controlling the high-beam bulb 103 and control signals for controlling the solenoid actuator 111, thereby controlling the operations of the high-beam bulb 103 and the solenoid actuator 111.

The high-beam control circuit fault determination device 131 can be realized by any conventional device that can determine whether the high-beam control circuit 127 operates normally. For example, the high-beam control circuit fault determination device 131 can be a watchdog timer. The watchdog timer can determine that the high-beam control circuit 127 is faulty if a signal is not input from the high-beam control circuit 127 for a specific period of time. Such a watchdog timer is well known to a person in the art, so further explanation of the same will be omitted.

In addition, the high-beam control circuit fault determination device 131 includes an on/off switch 133. The on/off switch 133 is controlled to be off if it is determined that the high-beam control circuit 127 is faulty. If the on/off switch 133 is off, the switching device 129 is isolated from an electric source 137, and thereby the switching device 129 is also off, so that the high-beam control circuit 127 is isolated from the external electric circuit 125.

In brief, when the high-beam control circuit 127 operates normally, the switching device 129 is controlled to be on, so that the high-beam bulb is controlled by control signals of the high-beam control circuit 127. However, when the high-beam control circuit 127 is faulty, the switching device 129 is off, so that the high-beam bulb is controlled by the external electric circuit 125.

Further, the integrated high-beam/infrared-ray lamp system 100 according to the preferred embodiment of the present invention includes a night vision main switch 135 that can be operated by a user or a driver.

As shown in FIG. 3, if the night vision main switch 135 is off, the switching device 129 is isolated from the electric source 137 so that the switching device 129 is off. Consequently, if the night vision main switch 135 is off, the high-beam control circuit 127 is isolated from the external electric circuit 125.

If a user perceives a malfunction or problems in the system, the user may operate the night vision main switch 135 to be off, and thereby the high-beam bulb 103 is not controlled by the high-beam control circuit 127.

FIG. 4 is a block diagram showing control of the high-beam bulb 103 and the solenoid actuator 111 performed by the lamp control unit 123. The lamp control unit 123 controls operations of the high-beam bulb 103 and the solenoid actuator 111 on the basis of signals of an ignition switch 139, a light switch 141, a night vision switch 143, an auto-light switch 145, and a vehicle speed sensor 147. Therefore, the integrated high-beam/infrared-ray lamp system 100 according to a preferred embodiment of the present invention can selectively act as a high-beam lamp or an infrared-ray lamp.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

In the integrated high-beam/infrared-ray lamp system according to the present invention, if the actuating device for operating the infrared-ray filter assembly does not operate, the infrared-ray filter does not screen the high-beam bulb, so the integrated high-beam/infrared-ray lamp system can be used as a high-beam lamp even when the actuating device for operating the infrared-ray filter assembly does not operate.

Further, the integrated high-beam/infrared-ray lamp system may determine a fault of the high-beam control circuit and may cope with the fault suitably, so that reliability of the system is increased.

Furthermore, because the integrated high-beam/infrared-ray lamp system according to the preferred embodiment of the present invention includes the night vision main switch, the driver may actively respond to a fault of the lamp system by preventing the high-beam control circuit from operating.

What is claimed is:

1. An integrated high-beam/infrared-ray lamp system, comprising:
a high-beam bulb disposed within a lamp housing;
an infrared-ray filter disposed in the housing, the infrared-ray filter being allowed to rotate between a first position where the infrared-ray filter screens the high beam lamp and a second position where the infrared-ray filter does not screen the high beam lamp;
an actuating device for rotating the infrared-ray filter; and
a lamp control unit for controlling on/off operation of the high beam bulb and the actuating unit,
wherein the actuating device comprises an actuator for actuating the infrared-ray filter and an elastic member elastically connecting the infrared-ray filter and the housing.

2. The integrated high-beam/infrared-ray lamp assembly of claim 1, wherein the actuator is a solenoid actuator.

3. The integrated high-beam/infrared-ray lamp assembly of claim 1, wherein the elastic member is a coil spring.

4. The integrated high-beam/infrared-ray lamp assembly of claim 1, wherein the elastic member connects the lamp housing and the infrared-ray filter such that the infrared-ray filter locates at the second position when the actuator does not operate.

5. An integrated high-beam/infrared-ray lamp system, comprising:
a high beam bulb disposed within a lamp housing;
an infrared-ray filter connected to the housing, the infrared-ray filter being allowed to rotate between a first position where the infrared-ray filter screens the high beam bulb and a second position where the infrared-ray filter does not screen the high beam bulb;
an actuating device for actuating the infrared-ray filter; and
a lamp control unit for controlling on/off operation of the high beam bulb and the infrared-ray filter,
wherein the lamp control unit comprises:
a high beam control circuit for generating a high beam bulb control signal to control the high beam bulb and an infrared-ray filter actuating device control signal to control the actuating device;
a switching device configured to perform on/off operation, the high beam control circuit being selectively connected to an external circuit that controls the high beam bulb in response to on/off operation of the switching device; and
a fault determination device determining a fault of the high beam control circuit and controlling the switching device to be on/off in response to a result of the fault determination of the high beam control circuit.

6. The integrated high-beam/infrared-ray lamp system of claim 5, wherein if the fault determination device determines the high beam control circuit to be faulty, the fault determination device controls the switching device to be off such that the high beam control circuit is separated from the external circuit.

7. The integrated high-beam/infrared-ray lamp system of claim 5, wherein the switching device is a relay switch.

8. The integrated high-beam/infrared-ray lamp system of claim 5, further comprising a night vision main switch configured to be operated by a user, wherein the switching device is operated to be on/off in response to on/off operation of the night vision main switch.
